(19) United States
(12) Patent Application Publication
(10) Pub. No.: US 2022/0121277 A1
(43) Pub. Date: Apr. 21, 2022

(54) CONTEXTUAL ZOOMING

(71) Applicant: Hewlett-Packard Development Company, L.P., Spring, TX (US)

(72) Inventors: Syed S. Azam, Spring, TX (US); Anthony Kaplanis, Spring, TX (US); Alexander Williams, Spring, TX (US)

(73) Assignee: Hewlett-Packard Development Company, L.P., Spring, TX (US)

(21) Appl. No.: 17/418,887

(22) PCT Filed: Jul. 1, 2019
(86) PCT No.: PCT/US2019/040115

§ 371 Date: Jun. 28, 2021

(51) Int. Cl. G06F 3/01; G06T 3/40

(52) U.S. Cl. CPC G06F 3/013; G06T 3/40

(57) ABSTRACT

Contextual zooming includes determining an area of interest on a display screen based on eye-tracking of a user. The area of interest may be represented as a set of coordinate points of a display signal. Contextual zooming also includes determining that a distance between the user and the display screen changes by a threshold amount. Scaling the display signal to expand the set of coordinate points on the display screen causes the area of interest to zoom.

### BACKGROUND

Computing systems often include a display screen to display information with which a user can interact. When operating computing systems, users may desire to enlarge one or more areas of the screen. For example, a user may zoom in on an area of the screen where they are working to enable better or more accurate interactions with content on the display screen.

### BRIEF DESCRIPTION OF THE DRAWINGS

Examples will now be described, by way of non-limiting example, with reference to the accompanying drawings, in which:

FIG. 1 illustrates a block diagram of a computing system for contextual zooming according to examples.

FIGS. 2A and 2B illustrate an example application of contextual zooming according to examples.

FIGS. 3A and 3B illustrate an example interaction with display device according to examples.

FIG. 4 illustrates a block diagram of a system for contextual zooming according to examples.

FIG. 5 is a flow diagram outlining an example method of contextual zooming according to examples.

### DETAILED DESCRIPTION

In various applications of computing systems, users may zoom in and out repeatedly to complete tasks. For example, while photo editing, a user may adjust the zoom level to have better control of fine details while zoomed in and change which part of an image is viewed by zooming out. Changing the zoom level is often accomplished with application-based tools. For example, a photo editing application may offer a number of ways to zoom into a photo. However, these can often impede the workflow of the user by having the user change a selected tool, enter keyboard commands, click a user interface component, or otherwise change operations from the task being performed.

These techniques for zooming in an application may not be intuitive to all users or may distract a user from a continuous workflow with an application. Furthermore, zooming on the application level may move the position of a mouse or other input device with respect to the image being displayed. There is also a subset of visually impaired users that want to continue to have a full desktop experience that is not permanently zoomed through the operating system or an application. Accordingly, disclosed herein are systems to provide an intuitive interface for zooming on a display device.

A contextual zoom system enables a user to interact with a display device in a similar manner as physical world interactions. The contextual zoom system determines, based on a user's position, whether to zoom into the screen, zoom out from the screen, or maintain a current level of zoom. For example, the contextual zoom system may enlarge a portion of the screen if a user leans toward the display device and return to an original size if the user returns to a baseline position. In some examples, determining to zoom includes additional user input. For example, the user may provide a command through an input device, such as a mouse or keyboard, that indicates to the contextual zoom system to begin analysis and performance of zooming functions based on the user's position.

In various examples, the contextual zoom system may track the position of a user in a variety of ways including video analysis, device tracking, depth sensors, or the like. For example, using video analysis, an image capture device may be integrated or attached to the display device. After detecting a user, the contextual zoom system can monitor the user and determine when the user moves closer or further from the display device. Other examples may use depth sensors, such as time of flight sensors, to monitor the position of the user. Furthermore, the display device may monitor the position of a device attached to the user. For example, if there is no image capture device, a device worn by the user can be tracked to determine the user's movement.

Based on the determined change in distance from a baseline position of the user, the contextual zoom system determines an amount of zoom to apply. The determination of the amount of zoom may be based on a magnitude of change in the user's position. For example, the contextual zoom system can determine a scalar amount by which to adjust the display signal based on the magnitude of the change from a baseline distance to, a current distance. Therefore, a larger scalar is determined for greater movement by the user. In some examples, the scalar selection may be a continuous function based on the determined position. In some examples, the scalar may be determined in part based on set thresholds to prevent unintentional zooming with small movements of the user.

The zooming is performed around an area of interest detected by the contextual zoom system. For example, the area of interest may be the current location of a pointer, a cursor, or another element of the currently displayed screen. In some examples, the area of interest may be determined based on eye-tracking. An image capture device may be integrated into or attached to the display device. The image capture device can be used to track the user's gaze and associate it to corresponding locations on the screen to define focal point. When the user moves closer to the display the display will zoom based on the user's gaze.

This zooming will be done by expanding and transforming the coordinate points on the display that are determined to fall in the area of interest. The contextual zoom system uses the coordinate points of the screen and a received display signal to scale the area of interest to be enlarged or fill the screen. The display signal is clipped and the area of interest is enlarged to fit the screen. For example, a set of coordinate points may be expanded by the determine scalar value.

Since the scalar knows the coordinate points of the screen, and the video signal that is being scaled to fit the current display. The video signal can be temporarily clipped and scaled again so that the user's region of interest now fills the screen. In this way, the scalar can then return to the full region of video based on the user's distance and positioning to the display. All scaling logic will be maintained by the scalar and coded in scalar firmware in this implementation, making the solution agnostic across platform. For example, the scaling may be performed by a contextual zoom system agnostic of operating system or hardware.

In some examples, the contextual zoom system is executed by the display device. For example, the display device may include a controller to detect the user's position and scale a received display signal based on the determination. Accordingly, a computing device providing a display signal may perform operations without an indication that the provided display signal is scaled at the display device. In other examples, the contextual zoom system may be partially of completely executed by a computing system. For example, an application or operating system may execute the contextual zoom system. As an example, the contextual zoom system may use an application programming interface to integrate with application based zooming functions. Additionally, the levels and sensitivity of the zoom could be adjusted within the contextual zoom system.

Although generally described as a display device attached to a computing device, other devices having display devices can utilize the contextual zoom system as described herein. For example, laptops, tablets, smartphones, or the like may perform the features described herein using similar operations. Furthermore, described examples that are executed by a display device may similarly be performed by a computing system attached to the display device.

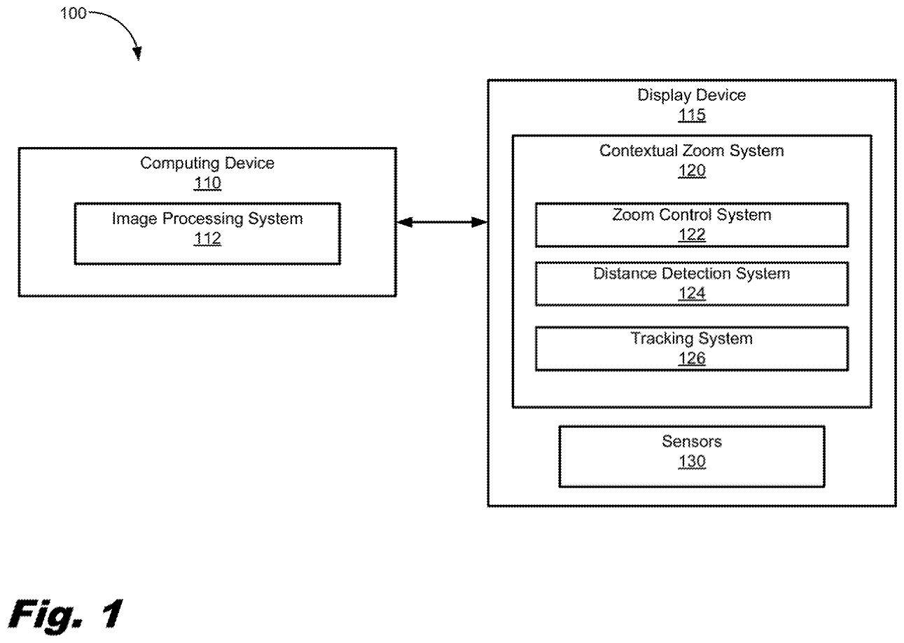

FIG. 1 is a block diagram showing a computing environment 100 having a contextual zoom system 120, according to some examples. For clarity, not all elements of a complete computing environment 100 are shown in FIG. 1. The computing environment 100 includes a computing device 110 and a display device 115.

The computing system 110 includes an image processing system 112 to generate a display signal to provide to the display device 115. For example, the image processing system 112 can generate images based on applications and operating systems executed on the computing device 110. The image processing system 112 transmits the display signal to the display device 115 to display. For example, the image processing system 112 can transmit the display signal over a serial or parallel interface, a wireless interface, or the like.

The display device 115 generates images on a display screen based at least in part on the received display signal. The display device 115 also includes a contextual zoom system 120. The contextual zoom system 120 may be executed in hardware, firmware, software or a combination of components to intuitively zoom based on a user's movements. The contextual zoom system 120 includes a zoom control system 122, a distance detection system 124, and tracking system 126. In various examples, the contextual zoom system 120 may include fewer or additional components than shown in FIG. 1.

The distance detection system 124 determines a distance between a user and the display device 115. The distance detection system 124 may include in hardware, firmware, software or a combination of components as well as sensors to provide data enabling detection of the position of a user with respect to a display device. For example, the distance detection system 124 may use video analysis of a video stream received from an image capture device, tracking of a device attached to a user, depth sensors, or the like. Sensors 130 may provide the data used by the distance detection system 124. Sensors 130 may include an image capture device, a time of flight sensor, an RFID reader, or other components that alone or in combination enable distance detection. Analysis of video from the image capture device 124 may include use of facial recognition technology. For example, if eye tracking is being performed, the location of the eyes is detected by the distance detection system 124. Accordingly, a change in the distance between the eyes in the detected face can be used to determine a change in distance. In various examples, other a change in a dimension of a feature of the face may be used to determine a change in distance of the user.

The tracking system 126 tracks the eye movement of a user to determine a gaze. The focal point of the determined gaze is associated with a set of coordinate points on the display device 115. An area that is “of-interest” for the user is accordingly tracked with respect to the users eye movement. In some examples, an area of interest may be determined by determining the range of eye movement over a period of time. The range of coordinates the eye has recently viewed may indicate an area of interest. In some examples, the area of interest may be the most recent focal point of the users gaze.

In some examples, the contextual zoom system 120 may not include a tracking, system 126. For example, in some work environments, image capture device's may not be allowed. Furthermore, a display device 115 may not include an image capture device, the image capture device may be off, or the image capture device may be broken. In such cases, an area of interest may be determined based on other information. For example, the computing device 110 may transmit coordinate information about an input device position, such as a mouse, a cursor position, an active application, or the like to the display device 115.

The zoom control system 122 uses data from the distance detection system 124 and the tracking system 126 to determine a scalar level to scale the display signal. For example, the zoom control system 122 may determine a baseline distance between the user and the display screen. By comparing a current distance between the user and the display screen to the baseline distance, the zoom control system 122 can determine whether to scale the display signal.

The zoom control system 122 may determine a level of the scalar based on the distance between the user and the display device 115. The scalar may be continuously changed based on changes in distance. For example, as a change is detected in the user's position may change the applied scalar may be updated. The scalar may also be changed based on a users distance from the display device 115 changing by a threshold amount. For example, the scalar may be updated incrementally as the distance is changed. This may prevent unintended zooming or zooming that is uncomfortable for the user. In addition, the amount of zoom applied may change based on user acceptance as well as the user's gestures. For example, if a user is leaning away from the screen to become more comfortable, the user may not want to change the current zoom of a screen. The zoom control system 122 may rather change a level of scalar applied to the zoom and update the display to accommodate user preferences.

The zoom control system 122 may also use the determined area of interest to generate a scaled display signal by expanding the set of coordinate points by the determined scalar. To improve perceived image quality, the zoom control system 122 may also perform resampling on the scaled image to reduce pixelization.

The display device 115 uses the scaled display signal to render an image on the display. Because the zoom is based around scaling the area of interest, the position of the input device relative to other displayed elements remains constant to improve the user experience. The processes performed by the contextual zoom system 120 can be repeated continuously as the distance detection system 124 registers a change in distance between the user and the display device 115.

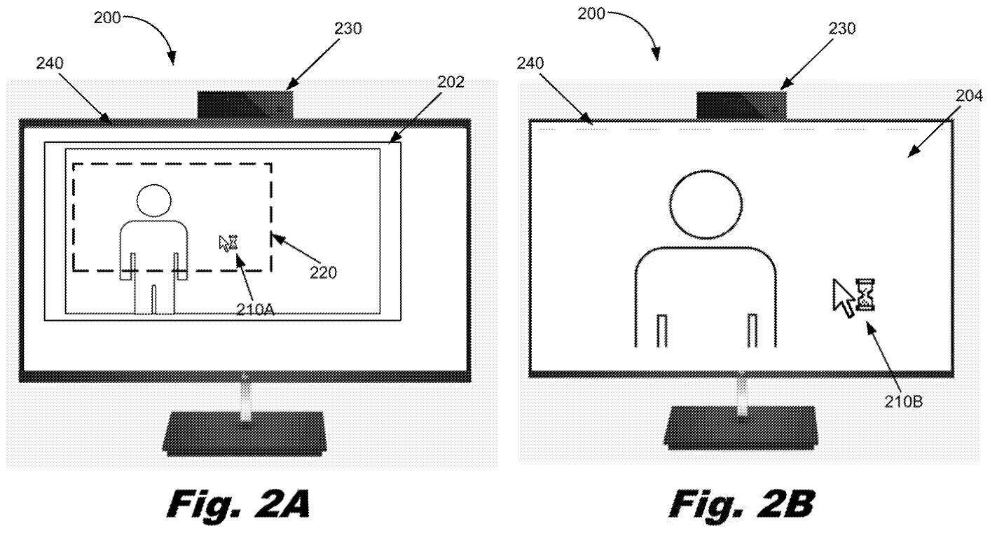

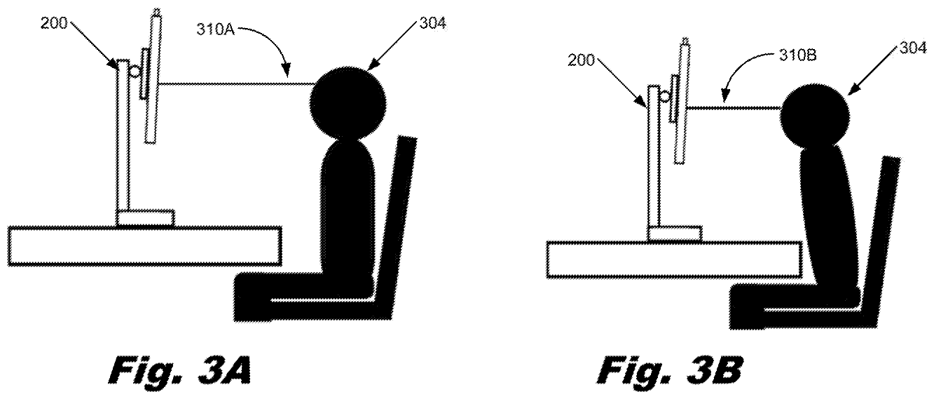

FIGS. 2A and 2B illustrate an example application of contextual zooming applied on a display device 200. The display device 200 may include an image capture device 230, a display screen 240, and a controller (not shown). FIGS. 3A and 3B illustrate corresponding positions of a user 304 interacting with display device 200. Accordingly, the display device 200 as illustrated in FIG. 2A is associated with the position of a user 304 in FIG. 3A and the display device 200 as illustrated in FIG. 2B is associated the position of a user 304 in FIG. 3B.

Starting with FIG. 2A, a display device 200 displays an image including an executing application 202. Within the executing application 202 there is shown an area of interest 220. The area of interest 220 may be determined by eye tracking based on video capture by image capture device 230. For example, the area of interest may be determined as a set of coordinates around a focal point of the user. Also shown is an input device pointer 210A demonstrating the current location where a user is working.

FIG. 3A shows the position of the user 304 while the example image in FIG. 2A is on the display screen 240. The user 304 is an initial distance of 310A from the display device 200. The distance may be determined based on the data from image capture device 230 or based on other sensors or readings. In some examples, a contextual zoom system may generate a threshold based on a baseline distance 310A of the user from the display screen. For example, a threshold may be set as a percentage of change an absolute amount of distance to change, or other factors. In some examples, the contextual zoom system may set a threshold in part on the magnitude of change in distance of the user. For example, if a user doesn't change position for a period of time, the contextual zoom system may reduce the threshold. In some examples, an initial distance of 310A may be changed if the user alters positions for a predetermined amount of time.

FIG. 3B shows the position of the user 304 that causes the example image in FIG. 2B to be displayed on the display screen 240. The user 304 has changed his position and is now a distance of 310B from the display device 200. The distance may be determined based on the same data used to determine the distance 310A in FIG. 3A. In some examples, a contextual zoom system may compare the change in distance to a determined threshold distance. For example, the current distance 310B may be compared to the threshold difference from distance 310A.

FIG. 2B, shows an updated image 204 on display device 200. Note that the application 202 was not present in the determined area of interest 220 and accordingly is not displayed on display screen 240. Rather the determined area of interest 220 is scaled to fill the display device 200. For example, the determined set of coordinate points may be expanded by the scalar value. Also shown is an input device pointer 210B, which is located with relation to the area of interest 220 in the same position as shown in FIG. 2A. In some examples, the area of interest 220 may not be scaled to fill the entire screen. For example, the area of interest 220 may be scaled and cover additional portions of the display screen 240 while background areas not covered by the scaled area of interest 220 remain displayed. To the extent that the are of interest is expanded, the contextual zoom system may determine a center for the area based on the position of an input device, such as a mouse, or based on an area of interest determined by the user's gaze.

After the contextual zoom system has performed the zooming shown in FIGS. 2A and 2B, the system continues to monitor the user to determine additional changes to the distance of the user from the display device 200. For example, the contextual zoom system may zoom in further by increasing the scalar in response to the distance diminishing or return to a non-zoomed scalar based on a user returning to a baseline position. As described with reference to FIG. 1, the contextual zoom system may be executed by hardware, software, or firmware display device 200 or as part of an application or operating system of a connected computing device.

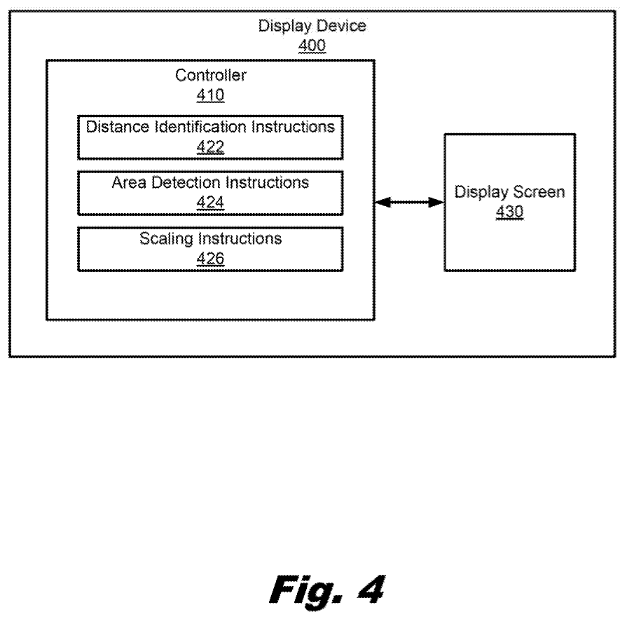

FIG. 4 is a block diagram of an example display device 400 to provide contextual zooming of a display signal. The display device 400 may be part of a computing device or connected to a computing device to receive a display signal. The display device 400 may include a display screen 430 as well as a controller 410. The display screen 430 displays images based on a display signal provided by the controller 410. The display screen 430 may be various types of screens as part of a number of products. For example, the display screen 430 may be an LED screen, an OLED screen, or other types of screen capable of rendering images based on a display signal.

The controller 410 may include a central processing unit (CPUs), a microprocessor, and/or other hardware devices suitable for retrieval and execution of instructions stored in a memory. In the display device 400, controller 410 may store and execute distance identification instructions 422, area detection instructions 424, and scaling instructions 426. As an alternative or in addition to storing and executing instructions, controller 410 may include an electronic circuit comprising a number of electronic components for performing the functionality of an instruction in memory. With respect to the executable instructions described and shown herein, it should be understood that part or all of the executable instructions and/or electronic circuits included within a particular box and/or may be included in a different box shown in the figures or in a different box not shown. A memory of controller 410 may be any electronic, magnetic, optical, or other physical storage device that stores executable instructions. Thus, memory may be, for example, Random Access Memory (RAM), an Electrically-Erasable Programmable Read-Only Memory (EEPROM), a storage drive, an optical disc, and the like.

Distance identification instructions 422 may, when executed, cause the processor 410 to determine a distance between a user and the display screen 430. The distance may be used to determine that the distance changed by a threshold amount. In some examples, the distance identification instructions 422 may determine an amount of distance, or an amount of change in distance, without determining that a threshold was satisfied.

The area detection instructions 424 may cause the controller to determine an area of interest of the display screen 430. For example, the area of interest may be based on eye tracking of the user, an input device location in the display signal, a running application on a computing device, or the like. The area of interest may be a focal point or a region of the screen.

The scaling instructions 426 cause the controller to determine a scalar value based on the determined distance and the area of interest. For example, the magnitude of distance changed between the user and the display screen may be translated into a scalar value to use when performing a zooming operation. The scaling instructions 426 may determine a set scalar value based upon the threshold that was satisfied. Furthermore, there may be additional thresholds that update the scalar further. Based on the determined scalar, the scaling instructions may cause the controller to scale the display signal to expand a set of coordinate points associated with the area of interest on the display. In various examples, the controller 410 may include fewer or additional sets of instructions than those illustrated in FIG. 4.

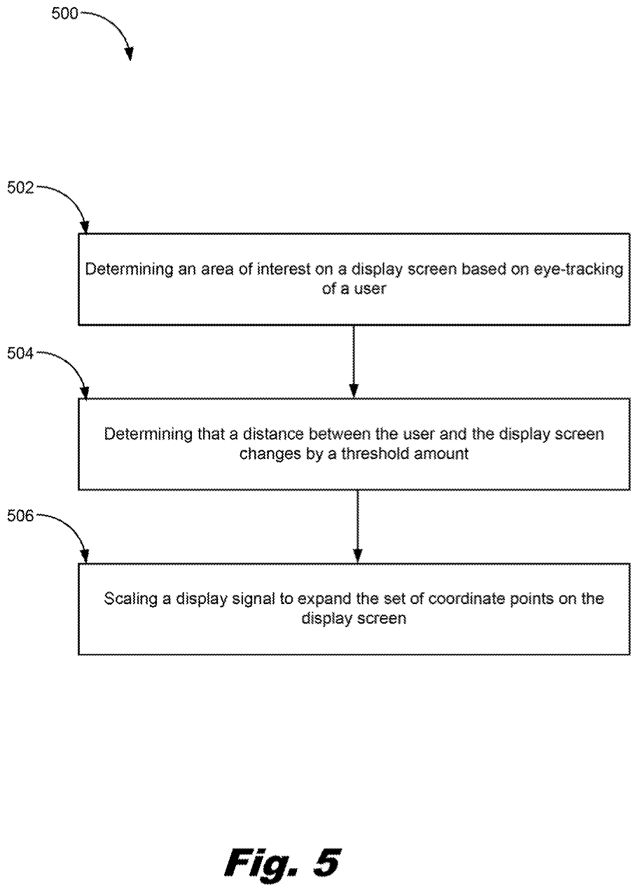

FIG. 5 illustrates an example flow diagram 500 that may be performed to provide contextual zooming. For example, the flow diagram may be performed by systems as described with reference to FIG. 1 above. In various examples, the processes described in reference to flow diagram 500 may be performed in a different order or the flow diagram may include fewer or additional blocks than are shown in FIG. 5.

Beginning in block 502, a contextual zoom system determines an area of interest on a display screen based on eye-tracking data corresponding to a user. For example, the eye-tracking may be performed based on analysis of images of the user captured by an image capture device. An image capture device may be integrated with or attached to the display screen, for instance. The area of interest may be a set of coordinate points of a display signal. In some examples, the area of interest may be a focal point of the user's gaze. In other example, an area of interest may be determined based on other or additional information such as mouse or other input device location in the display signal, active applications, or other tracking of areas of the display signal with which the user is interested.

In block 504, the contextual zoom system determines that a distance between the user and the display screen changes by a threshold amount. For example, the distance of a user from a display screen may be determined based on analysis of a video stream from an image capture device. The contextual zoom system may use facial recognition to identify one or more features of the user. The dimension of the feature in the video as the user changes position corresponds to a change in distance of the user from the display device. In some examples, additional or other sensors may be used to determine the position of a user and distance from a display screen. For example, depth sensors, device tracking sensors, or other sensors may determine the user's distance from the display screen. The contextual zoom system may use a current distance of the user and compare that to a baseline distance of the user to determine that the distance has changed by a threshold amount. The threshold may be set based on a percentage change in the distance or an absolute change in the distance between the user and the display screen.

In block 506, the contextual zoom system scales the display signal to expand the set of coordinate points on the display screen. For example, the scalar may be determined by the distance or threshold that the distance changed. The contextual zoom system may use the area of interest and scale that portion of the display signal by the determined scalar. Accordingly, the In area of interest may automatically be enlarged to the user's needs. If the user continues to change distance between herself and the display screen, the contextual zoom system can continue to update the scalar, and therefore level of zoom.

It will be appreciated that examples described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. In various examples other non-transitory computer-readable storage medium may be used to store instructions for implementation by processors as described herein. Accordingly, some examples provide a program comprising code for implementing a system or method as claimed in any subsequent claim and a machine-readable storage storing such a program.

The features disclosed in this specification (including any accompanying claims, abstract and drawings), and/or the operations or processes of any method or process so disclosed, may be combined in any combination, except combinations where at least some of such features and/or processes are mutually exclusive.

Each feature disclosed in this specification (including any accompanying claims, abstract, and drawings), may be replaced by alternative features serving the same, equivalent or similar purpose, unless expressly stated otherwise. Thus, unless expressly stated otherwise, each feature disclosed is an example of a generic series of equivalent or similar features.

1. A display device comprising:
a display screen; and
a controller operatively coupled to the display screen, the controller to:
determine that a distance between a user and the display screen changes by a threshold amount;
determine an area of interest on the display screen, wherein the area of interest comprises a set of coordinate points of a display signal; and
scale the display signal to expand the set of coordinate points on the display screen.

2. The display device of claim 1, wherein to determine the distance between the user and the display screen changes by the threshold amount, the controller is to:
receive a video stream from an image capture device;
identify a face of the user in video stream; and
determine the distance between the user and the display screen based on a dimension of a feature of the face.

3. The display device of claim 1, wherein to determine the area of interest on the display screen, the controller is further to:
receive a video stream from an image capture device;
perform eye-tracking to identify a region of the display screen that the user is viewing.

4. The display device of claim 1, wherein the controller is further to:
determine that the distance between the user and the display screen returns to a baseline position; and
scale the display signal to fit the display screen.

5. The display device of claim 1, wherein the controller is further to select dimensions of the set of coordinate points based on a magnitude of change in the distance between the user and the display screen.

6. The display device of claim 1, wherein the controller is further to:
determine that the distance between the user and the display screen changes by a second threshold amount; and
scale the display signal by a second amount to further expand the set of coordinate points on the display screen.

7. The display device of claim 1, wherein to determine the distance between the user and the display changes the controller is further to:
receiving a signal from a tracking device; and
determine based on the signal, that a position of the tracking device changed with respect to the display screen.

8. The display device of claim 1, wherein to determine the area of interest, the controller is further to:
receive a signal indicating an input device position with respect to the display signal; and
identify the area of interest based on the input device position.

9. A method comprising:
determining an area of interest on a display screen based on eye-tracking of a user, wherein the area of interest comprises a set of coordinate points of a display signal;
determining that a distance between the user and the display screen changes by a threshold amount; and
scaling the display signal to expand the set of coordinate points on the display screen.

10. The method of claim 9, further comprising selecting dimensions of the set of coordinate points based on a magnitude of change in the distance between the user and the display screen.

11. The method of claim 9, further comprising:
determining that the distance between the user and the display screen changes by a second threshold amount; and
scaling the display signal by a second amount to further expand the set of coordinate points on the display screen.

12. The method of claim 9, further comprising:
determining that the distance between the user and the display screen returns to a baseline position; and
scaling the display signal to fit the display screen.

13. A system comprising:
a display screen; and
a controller operatively coupled to the display screen, the controller to:
set a baseline distance between a user and the display screen;
determine that a current distance between a user and the display screen is different than the baseline distance by a threshold amount;
determine an area of interest on the display screen, wherein the area of interest comprises a set of coordinate points of a display signal; and
scale the display signal to expand the ;set of coordinate points on the display screen.

14. The system of claim 13, wherein to scale the display signal, the controller is to set a scalar value based on the current distance between the user and the display screen.

15. The system of claim 13, wherein the controller is further to receive the display signal from an external computing device.
